(19) United States
(12) Patent Application Publication
(10) Pub. No.: US 2025/0239791 A1
(43) Pub. Date: Jul. 24, 2025

(54) CABLE-END CONNECTOR, BOARD-END CONNECTOR AND ASSEMBLY THEREOF

(71) Applicant: Molex, LLC, Lisle, IL (US)

(72) Inventors: Yi-Tse Ho, New Taipei City (TW); Ricardo Alvarez Gonzalez, Lisle, IL (US); Robert Piszczor, LaGrange, IL (US)

(21) Appl. No.: 19/173,843

(22) Filed: Apr. 9, 2025

Related U.S. Application Data
(63) Continuation of application No. 17/902,494, filed on Sep. 2, 2022.

(30) Foreign Application Priority Data
Sep. 7, 2021 (CN) 202111042872.0
Jul. 11, 2022 (CN) 202210811606.8

(51) Int. Cl. H01R 12/70; H01R 13/518

(52) U.S. Cl. CPC H01R 12/7029; H01R 13/518

(57) ABSTRACT

An assembly of a cable-end connector and a board-end connector comprises a cable-end connector and a board-end connector. The cable-end connector comprises an outer casing having a recessed portion, a first contact member, a second contact member, a first cable, a second cable, and a first locking structure, at least part of which is positioned in the recessed portion. The board-end connector is used to mate with the cable-end connector, and the board-end connector comprises a blocking seat, a third contact member, a fourth contact member and a second locking structure. In the present disclosure, by virtue of the triangular arrangement of the recessed portion, the first contact member and the second contact member, and the triangular arrangement of the third contact member, the fourth contact member and the second locking structure, the cable-end connector and the board-end connector can be reduced in width along a lateral direction, and design spaces respectively for the first locking structure and the second locking structure can be reserved, so that the space of the cable-end connector and the space of the board-end connector can be used effectively.

### FIELD OF THE DISCLOSURE

The present disclosure relates to a cable-end connector, more particularly to a cable-end connector, a board-end connector and an assembly thereof.

### BACKGROUND

Chinese Invention Patent No. CN103872484B discloses an electric connector assembly, wherein a first contact portion of a long terminal and a first contact portion of a short terminal are inserted into an elastic cylindrical member received in a corresponding first receiving terminal of a first attachment connector. When being further inserted, the first contact portion of the long terminal and the first contact portion of the short terminal each move down while elastically increasing the diameter of an annular neck section of the corresponding elastic cylindrical member, so as to reach a predetermined position. Each elastic cylindrical member, the diameter of which has been elastically increased, elastically contacts the outer circumferential surface of the first contact portion and the first contact portion, and elastic contact pressure against the inner surface of the receiving hole of the first receiving terminal is increased. Thereafter, an intermediate connector is secured onto a first circuit board using locking screws. When it is desired to remove the intermediate connector from the first circuit board, the intermediate connector is lifted up after the locking screws are removed. Specifically, the contact portions of the terminals are arranged laterally, and the lateral width of a connector that is designed based on such an arrangement is limited by the combined width of the two contact portions and is hard to be reduced.

### SUMMARY

Therefore, an object of the present disclosure is to provide a cable-end connector, a board-end connector and an assembly thereof that can solve at least one drawback of the conventional technique.

Accordingly, in some implementation examples, a cable-end connector of the present disclosure comprises an outer casing, a first contact member, a second contact member, at least one first cable, at least one second cable, and a first locking structure. The outer casing has a mating surface and a recessed portion. The first contact member is disposed in the outer casing and extends toward the mating surface. The second contact member is disposed in the outer casing and extends toward the mating surface. The first cable extends into the outer casing and is electrically connected to the first contact member. The second cable extends into the outer casing and is electrically connected to the second contact member. The first locking structure is disposed on the outer casing, and at least part of the first locking structure is positioned in the recessed portion. Specifically, the recessed portion, the first contact member and the second contact member are triangularly arranged.

In some implementation examples, the mating surface is located at the bottom, and the outer casing further has a front end surface and a rear end surface that are opposite to each other, and a first side surface and a second side surface that are opposite to each other. The front end surface, the rear end surface, the first side surface and the second side surface are each formed by extending from a respective side edge of the mating surface. The recessed portion is adjacent to the front end surface or the rear end surface.

In some implementation examples, the first contact member includes a first mating portion that is disposed in the outer casing and extends toward the mating surface, and a first connecting portion that is connected to the first mating portion; the second contact member includes a second mating portion that is disposed in the outer casing and extends toward the mating surface, and a second connecting portion that is connected to the second mating portion; the first cable is electrically connected to the first connecting portion, and the second cable is electrically connected to the second connecting portion.

In some implementation examples, the first locking structure, the first contact member and the second contact member are triangularly arranged.

In some implementation examples, the recessed portion is adjacent to a corner of the front end surface and the second side surface, the first contact member is adjacent to a corner of the front end surface and the first side surface, and the second contact member is adjacent to a corner of the rear end surface and the second side surface.

In some implementation examples, the outer casing is formed by over molding.

In some implementation examples, the outer casing includes a housing and a cover that are assembled with each other.

In some implementation examples, the housing has two through grooves accommodating the first contact member and the second contact member, respectively. Each through groove is provided with a stopping edge at the bottom and adjacent to the mating surface, and an elastic stopping arm extending from the top into the through groove. The stopping edges of the two through grooves are used to stop a bottom edge of the first contact member and a bottom edge of the second contact member, respectively. The elastic stopping arms of the two through grooves are used to stop an upper stopping surface of the first contact member and an upper stopping surface of the second contact member, respectively.

In some implementation examples, the first mating portion includes a barrel body, and a cage-shaped contact body disposed in the barrel body. The second mating portion includes a barrel body, and a cage-shaped contact body disposed in the barrel body.

In some implementation examples, the cage-shaped contact body of each of the first mating portion and the second mating portion has an annular head portion, and an elastic contact piece formed by extending from the annular head portion.

In some implementation examples, the first locking structure has a cantilevered arm extending downwardly, and a first latching unit disposed on the bottom of the cantilevered arm.

In some implementation examples, the first locking structure has an opening extending through it in an up-down direction.

In some implementation examples, the first locking structure has an opening extending through it in an up-down direction, and a locking screw rotatably extending through the opening.

In some implementation examples, projections of the first contact member and the second contact member on the front end surface are partially overlapped with each other.

In some implementation examples, projections of the first contact member and the second contact member on the first side surface are partially overlapped with each other.

In some implementation examples, the first cable and the second cable extend through the rear end surface into the outer casing and are electrically connected to the first connecting portion and the second connecting portion, respectively.

In some implementation examples, the outer casing further has an upper end surface spaced apart from and opposite to the mating surface, and the first cable and the second cable extend through the upper end surface into the outer casing and are electrically connected to the first connecting portion and the second connecting portion, respectively.

In some implementation examples, the first connecting portion and the second connecting portion are in a shape of a board, and the first cable and the second cable are electrically connected to opposite backside surfaces of the first connecting portion and the second connecting portion, respectively.

Accordingly, in some implementation examples, a board-end connector of the present disclosure comprises a blocking seat, a third contact member, a fourth contact member, and a second locking structure. The third contact member includes a third connecting portion disposed on the blocking seat, and a third mating portion formed by extending upward from the third connecting portion. The fourth contact member includes a fourth connecting portion disposed on the blocking seat, and a fourth mating portion formed by extending upward from the fourth connecting portion. The second locking structure is disposed on the blocking seat. Specifically, the third contact member, the fourth component and the second locking structure are triangularly arranged.

In some implementation examples, the blocking seat is a circuit board, the third connecting portion is electrically connected to the circuit board, and the fourth connecting portion is electrically connected to the circuit board.

In some implementation examples, the third contact member further has a stopping portion that is stopped by a top surface of the circuit board, and the fourth contact member further has a stopping portion that is stopped by the top surface of the circuit board.

In some implementation examples, the third contact member further has a raising projection that is stopped by a top surface of the circuit board to raise a space for solder filling, and the fourth contact member further has a raising projection that is stopped by the top surface of the circuit board to raise a space for solder filling.

In some implementation examples, the circuit board has a rectangular region, a first corner and a second corner that are positioned diagonally opposite within the rectangular region, and a third corner that is positioned within the rectangular region; the third contact member is disposed in the first corner; the fourth contact member is disposed in the second corner so as to be arranged diagonally to the third contact member; the second locking structure is disposed in the third corner.

In some implementation examples, the second locking structure includes a base portion extending upwardly, and a second latching unit disposed on the base portion.

In some implementation examples, the second locking structure includes a base portion extending upwardly, and a threaded hole disposed on the base portion.

In some implementation examples, the blocking seat is a seat body in a rectangular shape, the seat body has two through holes each extending through it in the up-down direction, and the third mating portion and the fourth mating portion extend upwardly out of the two through holes, respectively.

In some implementation examples, the second locking structure is formed to be constructed integrally from the seat body.

In some implementation examples, the third contact member further has an interference rib used to interfere with an inner wall surface of the corresponding through hole, and the fourth contact member further has an interference rib used to interfere with an inner wall surface of the corresponding through hole.

In some implementation examples, the third contact member further has a stopping portion that is stopped by a top surface of the seat body, and the fourth contact member further has a stopping portion that is stopped by the top surface of the seat body.

In some implementation examples, the third mating portion and the fourth mating portion are cylindrical in shape.

Accordingly, in some implementation examples, an assembly of a cable-end connector and a board-end connector comprises a cable-end connector and a board-end connector. The cable-end connector comprises an outer casing, a first contact member, a second contact member, at least one first cable, at least one second cable, and a first locking structure. The outer casing has a mating surface and a recessed portion. The first contact member is disposed in the outer casing and extends toward the mating surface. The second contact member is disposed in the outer casing and extends toward the mating surface. The first cable extends into the outer casing and is electrically connected to the first contact member. The second cable extends into the outer casing and is electrically connected to the second contact member. The first locking structure is disposed on the outer casing, and at least part of the first locking structure is positioned in the recessed portion. Specifically, the recessed portion, the first contact member and the second contact member are triangularly arranged. The board-end connector comprises a blocking seat, a third contact member, a fourth contact member, and a second locking structure. The third contact member includes a third connecting portion disposed on the blocking seat, and a third mating portion formed by extending upward from the third connecting portion and used to mate with the first mating portion. The fourth contact member includes a fourth connecting portion disposed on the blocking seat, and a fourth mating portion formed by extending upward from the fourth connecting portion and used to mate with the second mating portion. The second locking structure is disposed on the blocking seat, and the second locking structure is used to interlock with the first locking structure. Specifically, the third contact member, the fourth component and the second locking structure are triangularly arranged.

In some implementation examples, the mating surface is located at the bottom, and the outer casing further has a front end surface and a rear end surface that are opposite to each other, and a first side surface and a second side surface that are opposite to each other. The front end surface, the rear end surface, the first side surface and the second side surface are each formed by extending from a respective side edge of the mating surface. The recessed portion is adjacent to the front end surface or the rear end surface.

In some implementation examples, the first contact member includes a first mating portion that is disposed in the outer casing and extends toward the mating surface, and a first connecting portion that is connected to the first mating portion; the second contact member includes a second mating portion that is disposed in the outer casing and extends toward the mating surface, and a second connecting portion that is connected to the second mating portion; the first cable is electrically connected to the first connecting portion, and the second cable is electrically connected to the second connecting portion.

In some implementation examples, the first locking structure, the first contact member and the second contact member are triangularly arranged.

In some implementation examples, the recessed portion is adjacent to a corner of the front end surface and the second side surface, the first contact member is adjacent to a corner of the front end surface and the first side surface, and the second contact member is adjacent to a corner of the rear end surface and the second side surface.

In some implementation examples, the outer casing is formed by over molding.

In some implementation examples, the outer casing includes a housing and a cover that are assembled with each other.

In some implementation examples, the outer casing has two through grooves accommodating the first contact member and the second contact member, respectively. Each through groove is provided with a stopping edge at the bottom and adjacent to the mating surface, and an elastic stopping arm extending from the top into the through groove. The stopping edges of the two through grooves are used to stop a bottom edge of the first contact member and a bottom edge of the second contact member, respectively. The elastic stopping arms of the two through grooves are used to stop an upper stopping surface of the first contact member and an upper stopping surface of the second contact member, respectively.

In some implementation examples, the first mating portion includes a barrel body and a cage-shaped contact body disposed in the barrel body, the second mating portion includes a barrel body and a cage-shaped contact body disposed in the barrel body; the third mating portion and the fourth mating portion are cylindrical in shape and are used to be electrically connected to the cage-shaped contact body of the first mating portion and the cage-shaped contact body of the second mating portion, respectively.

In some implementation examples, the cage-shaped contact body of each of the first mating portion and the second mating portion has an annular head portion, and an elastic contact piece formed by extending from the annular head portion.

In some implementation examples, the first locking structure has a cantilevered arm extending downwardly, and a first latching unit disposed on the bottom of the cantilevered arm; the second locking structure includes a base portion extending upwardly, and a second latching unit disposed on the base portion and used to be fastened to the first latching unit.

In some implementation examples, the second locking structure includes a base portion extending upwardly, and a threaded hole disposed on the base portion; the first locking structure has an opening extending through it in an up-down direction, and a locking screw rotatably extending through the opening and used to engage with the threaded hole.

In some implementation examples, the blocking seat is a circuit board, the third connecting portion is electrically connected to the circuit board, and the fourth connecting portion is electrically connected to the circuit board.

In some implementation examples, the third contact member further has a stopping portion that is stopped by on a top surface of the circuit board, and the fourth contact member further has a stopping portion that is stopped by the top surface of the circuit board.

In some implementation examples, the third contact member further has a raising projection that is stopped by a top surface of the circuit board to raise a space for solder filling, and the fourth contact member further has a raising projection that is stopped by the top surface of the circuit board to raise a space for solder filling.

In some implementation examples, the blocking seat is a seat body, the seat body has two through holes each extending through it in the up-down direction, the third mating portion and the fourth mating portion extend upwardly out of the two through holes, respectively, and the second locking structure is formed to be constructed integrally from the seat body.

In some implementation examples, the third contact member further has a stopping portion that is stopped by a top surface of the seat body, and the fourth contact member further has a stopping portion that is stopped by the top surface of the seat body.

In some implementation examples, the third contact member further has an interference rib used to interfere with an inner wall surface of the corresponding through hole, and the fourth contact member further has an interference rib used to interfere with an inner wall surface of the corresponding through hole.

In some implementation examples, projections of the first contact member and the second contact member on the front end surface are partially overlapped with each other.

In some implementation examples, projections of the first contact member and the second contact member on the first side surface are partially overlapped with each other.

In some implementation examples, the first cable and the second cable extend through the rear end surface into the outer casing and are electrically connected to the first connecting portion and the second connecting portion, respectively.

In some implementation examples, the outer casing further has an upper end surface spaced apart from and opposite to the mating surface, and the first cable and the second cable extend through the upper end surface into the outer casing and are electrically connected to the first connecting portion and the second connecting portion, respectively.

In some implementation examples, the first connecting portion and the second connecting portion are in a shape of a board, and the first cable and the second cable are electrically connected to opposite backside surfaces of the first connecting portion and the second connecting portion, respectively.

In some implementation examples, the cable-end connector further has an abutting rib disposed within the recessed portion of the outer casing, and the abutting rib allows the first locking structure to abut against it. The second locking structure of the board-end connector includes an avoiding groove corresponding to the abutting rib, and the avoiding groove is used to avoid the abutting rib when the first locking structure interlocks with the second locking structure.

In the present disclosure, by virtue of the first contact member and the second contact member that are diagonally arranged and that are arranged in a triangular arrangement with the first locking structure, and the third contact member and the fourth contact member that are diagonally arranged, the cable-end connector and the board-end connector can be reduced in width along a lateral direction, and designed spaces respectively for the first locking structure and the second locking structure can be reserved, so that the space of the cable-end connector and the space of the board-end connector can be used effectively. Also, the dimensions of the first locking structure and the second locking structure can be designed to be larger to enhance structural strength thereof.

### BRIEF DESCRIPTION OF THE DRAWINGS

Other features and effects related to the present disclosure will be apparently presented in the embodying manner with reference to the drawings, in which:

FIG. 1 is a perspective view of a first embodiment of an assembly of a cable-end connector and a board-end connector of the present disclosure;

FIG. 2 is an exploded perspective view of the first embodiment;

FIG. 3 is an exploded perspective views of the first embodiment shown in FIG. 2 when viewed from another viewing angle;

FIG. 4 is an exploded perspective view of the first embodiment shown in FIG. 2 when viewed from yet another viewing angle;

FIG. 5 is a further exploded perspective view of the first embodiment;

FIG. 6 is an exploded perspective view of the first embodiment shown in FIG. 5 when viewed from another viewing angle;

FIG. 7 is a top view of the cable-end connector of the first embodiment, wherein a cable and a cover of an outer casing of the cable-end connector are omitted from the drawing;

FIG. 8 is a cross-sectional view taken along line A-A in FIG. 7;

FIG. 9 is a top view of the board-end connector of the first embodiment;

FIG. 10 is a perspective view of a third contact member of the board-end connector of the first embodiment;

FIG. 11 is a cross-sectional view of the first embodiment;

FIG. 12 is a perspective view of a board-end connector of a second embodiment of the present disclosure;

FIG. 13 is an exploded perspective view of a third embodiment of the present disclosure;

FIG. 14 is an exploded perspective view of the third embodiment shown in FIG. 13 when viewed from another viewing angle;

FIG. 15 is an exploded perspective view of a fourth embodiment of the present disclosure;

FIG. 16 is a perspective view of a cable-end connector of a fifth embodiment of the present disclosure;

FIG. 17 is an exploded perspective view of the cable-end connector of the fifth embodiment;

FIG. 18 is a perspective view of a board-end connector of a sixth embodiment of the present disclosure;

FIG. 19 is an exploded perspective view of the board-end connector of the sixth embodiment;

FIG. 20 is an exploded perspective view of the sixth embodiment shown in FIG. 19 when viewed from another viewing angle;

FIG. 21 is an exploded perspective view of a seventh embodiment of the present disclosure;

FIG. 22 is an exploded perspective view of the seventh embodiment shown in FIG. 21 when viewed from another viewing angle;

FIG. 23 is a schematic side view of a cable-end connector of the seventh embodiment; and

FIG. 24 is a cross-sectional view of the seventh embodiment, wherein the cable-end connector and a board-end connector of the seventh embodiment mate with each other in the drawing.

### DETAILED DESCRIPTION

Before the present disclosure is described in detail, it should be noted that similar components are indicated by the same reference numerals in the following description.

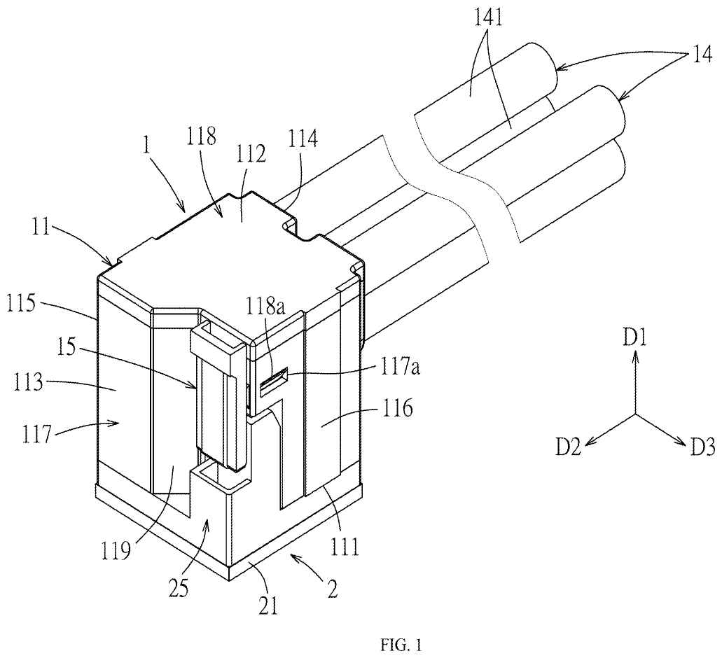

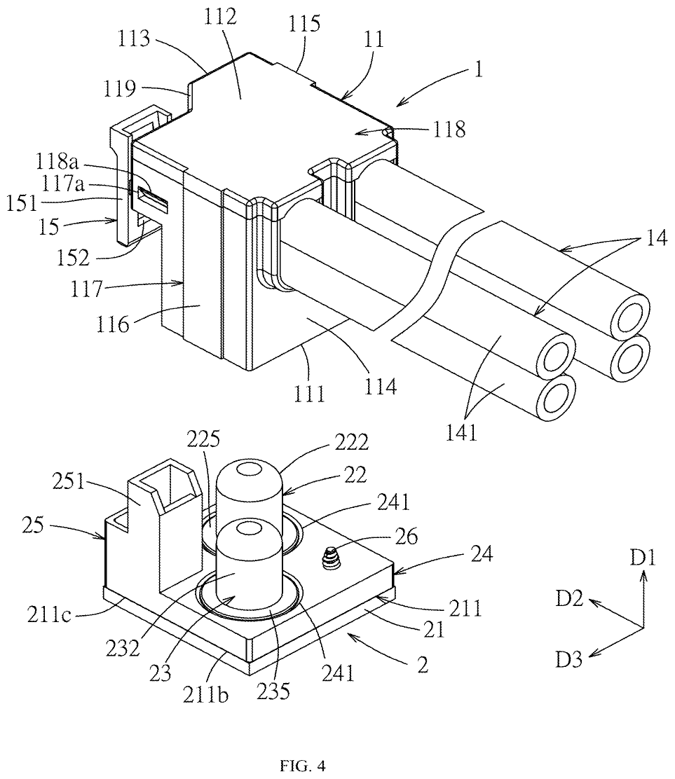

Referring to FIGS. 1-4, a first embodiment of an assembly of a cable-end connector 1 and a board-end connector 2 of the present disclosure comprises a cable-end connector 1 and a board-end connector 2.

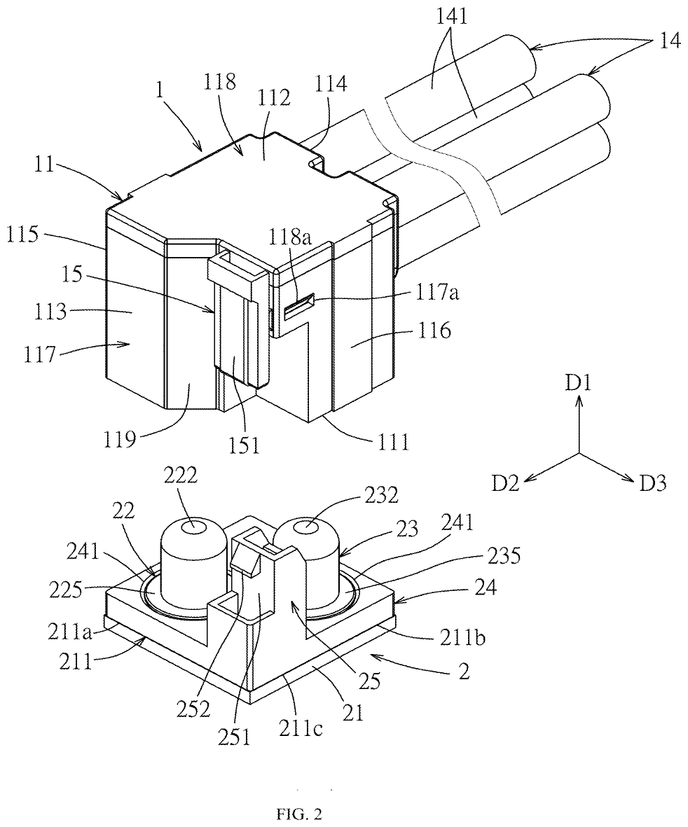

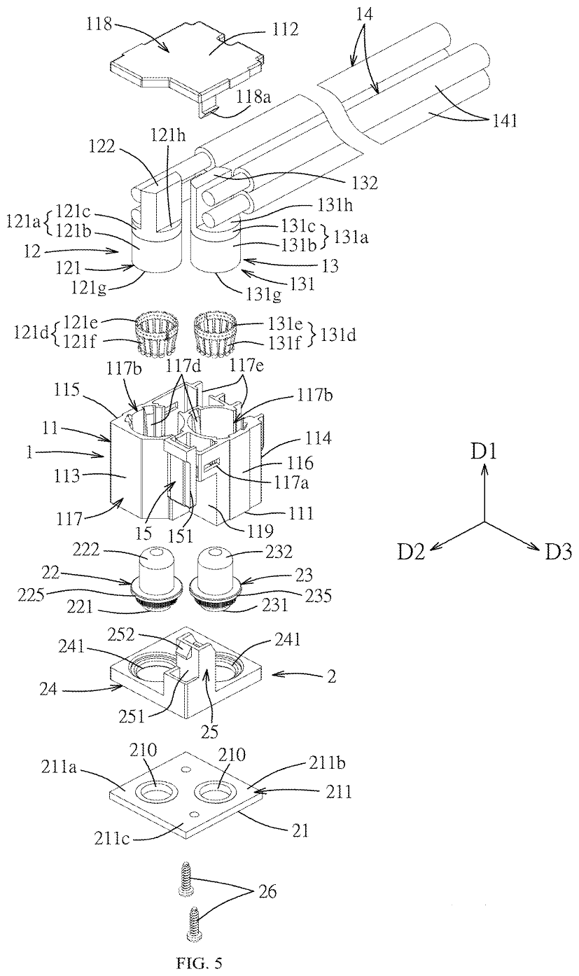

Referring to FIGS. 2 and 4-6, the cable-end connector 1 comprises an outer casing 11, a first contact member 12, a second contact member 13, two cables 14 and a first locking structure 15.

The outer casing 11 is made of an insulating material, and has a mating surface 111 and an upper end surface 112 that are located respectively at the bottom and the top and that are spaced apart from and opposite to each other in an up-down direction D1 (a direction which the arrow points to is up, and a reverse direction is down), a front end surface 113 and a rear end surface 114 that are opposite to each other in a front-rear direction D2 (a direction which the arrow points to is front, and a reverse direction is rear), and a first side surface 115 and a second side surface 116 that are opposite to each other in a left-right direction D3 (a direction which the arrow points to is right, and a reverse direction is left). The front end surface 113, the rear end surface 114, the first side surface 115 and the second side surface 116 are each formed by extending from a respective side edge of the mating surface 111 in the up-down direction. In the first embodiment, the outer casing 11 includes a housing 117 and a cover 118 that are assembled with each other in the up-down direction D1. For example, the housing 117 has two latching holes 117a, and the cover 118 has two latching elastic arms 118a that latch respectively with the two latching holes 117a.

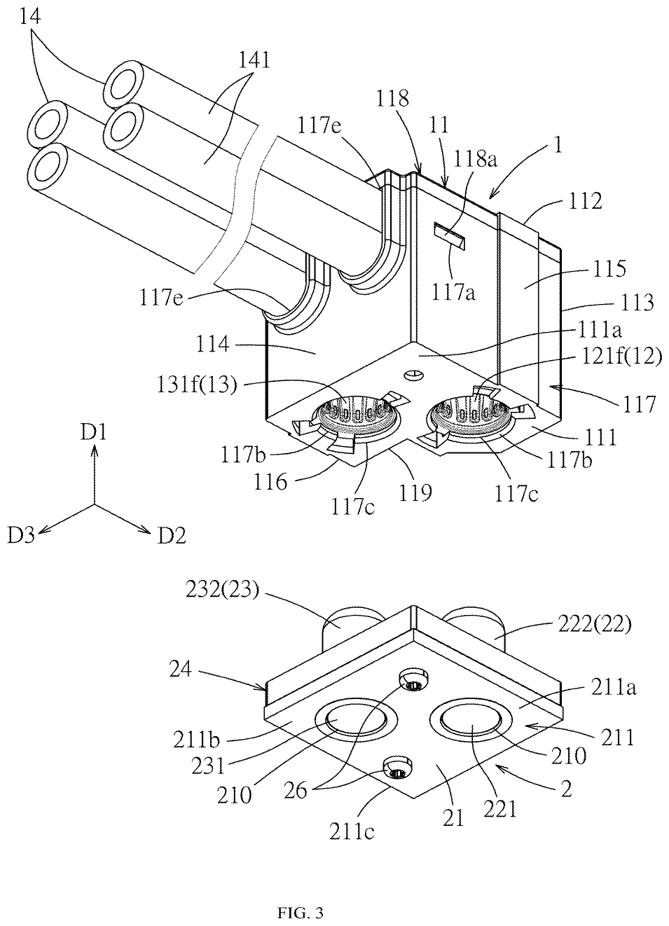

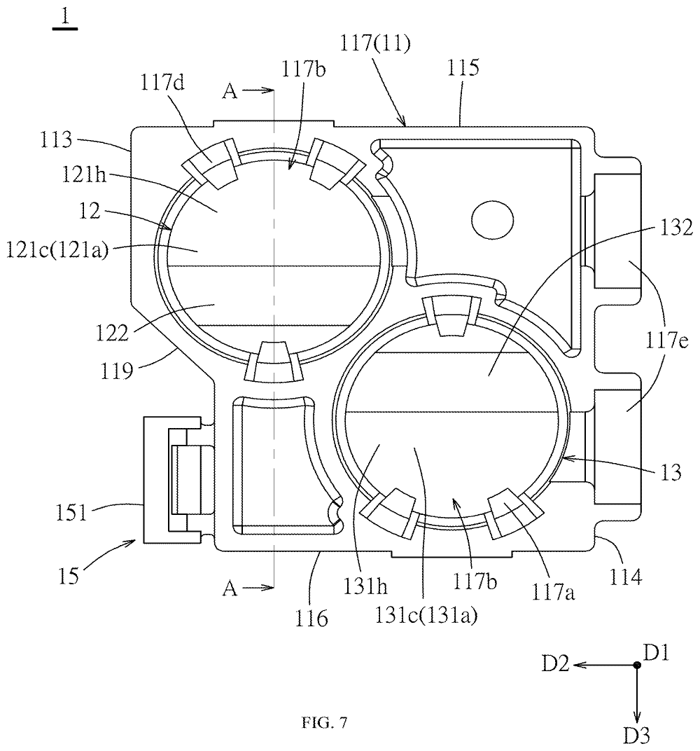

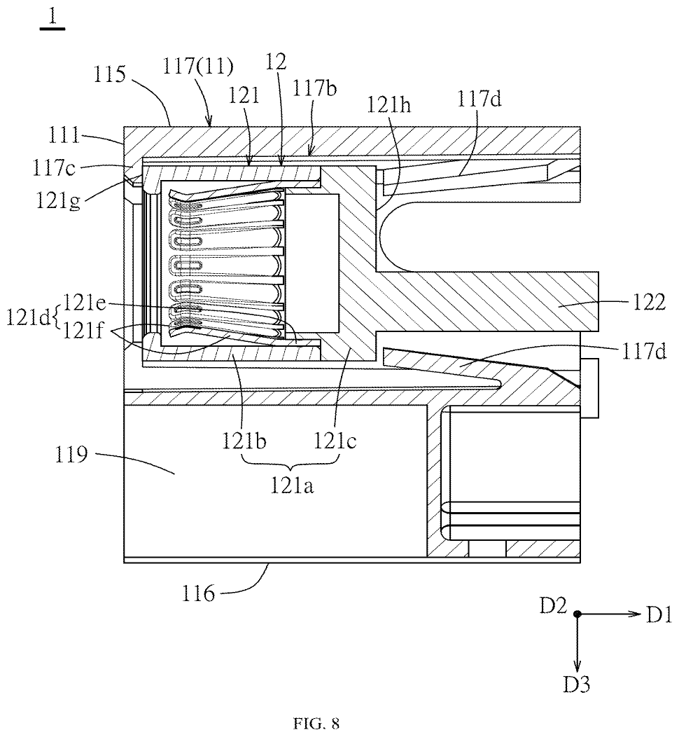

Referring to FIGS. 3 and 5-8, the first contact member 12 extends in the up-down direction D1, and is disposed within the outer casing 11 and adjacent to a corner between the front end surface 113 and the first side surface 115. The first contact member 12 includes a first mating portion 121 that is disposed within the outer casing 11 and that extends toward the mating surface 111, and a first connecting portion 122 that is disposed within the outer casing 11 and that is connected to the first mating portion 121. The second contact member 13 extends in the up-down direction D1, and is disposed within the outer casing 11 and adjacent to a corner between the rear end surface 114 and the second side surface 116 so as to be arranged diagonally to the first contact member 12. The second contact member 13 includes a second mating portion 131 that is disposed within the outer casing 11 and that extends toward the mating surface 111, and a second connecting portion 132 that is disposed within the outer casing 11 and that is connected to the second mating portion 131. In the first embodiment, projections of the first contact member 12 and the second contact member 13 on the front end surface 113 are partially overlapped with each other, and projections of the first contact member 12 and the second contact member 13 on the first side surface 115 are also partially overlapped with each other.

In detail, the first mating portion 121 includes a barrel body 121a, and a cage-shaped contact body 121d disposed in the barrel body 121a. The barrel body 121a includes a tubular member 121b that is disposed at the lower end, and a lid-shaped member 121c that is disposed at the top of the tubular member 121b and that cooperates with the tubular member 121b to clip the cage-shaped contact body 121d. The cage-shaped contact body 121d has an annular head portion 121e clipped by the tubular member 121b and the lid-shaped member 121c together, and a plurality of elastic contact pieces 121f extending downwardly from the annular head portion 121e toward the mating surface 111. In addition, the first connecting portion 122 is in a shape of a plate, and is formed to integrally extend upwardly from a top surface of the lid-shaped member 121c of the first mating portion 121. The second mating portion 131 includes a barrel body 131a, and a cage-shaped contact body 131d disposed in the barrel body 131a. The barrel body 131a includes a tubular member 131b that is disposed at the lower end, and a lid-shaped member 131c that is disposed at the top of the tubular member 131b and that cooperates with the tubular member 131b to clip the cage-shaped contact body 131d. The cage-shaped contact body 131d has an annular head portion 131e clipped by the tubular member 131b and the lid-shaped member 131c together, and a plurality of elastic contact pieces 131f extending downwardly from the annular head portion 131e toward the mating surface 111. In addition, the second connecting portion 132 is in a shape of a plate, and is formed to integrally extend upwardly from a top surface of the lid-shaped member 131c of the second mating portion 131.

The housing 117 has two through grooves 117b extending in the up-down direction D1 to the mating surface 111 and accommodating the first contact member 12 and the second contact member 13, respectively. Each through groove 117b is provided with a stopping edge 117c at the bottom and adjacent to the mating surface 111, and an elastic stopping arm 117d extending from the top into the through groove 117b. The stopping edges 117c of the two through grooves 117b are used to stop a bottom edge 121g of the barrel body 121a of the first contact member 12 and a bottom edge 131g of the barrel body 131a of the second contact member 13, respectively. The elastic stopping arms 117d of the two through grooves 117b are used to stop an upper stopping surface 121h of the barrel body 121a of the first contact member 12 and an upper stopping surface 131h of the barrel body 131a of the second contact member 13, respectively.

The two cables 14 extend respectively into the two through grooves 117b respectively through two cable passing holes 117e of the housing 117 of the outer casing 11 in the rear end surface 114, and are electrically connected to the first connecting portion 122 and the second connecting portion 132, respectively. Specifically, the two cables 14 are electrically connected to opposite backside surfaces of the board-shaped first connecting portion 122 and the board-shaped second connecting portion 132, respectively. It should be noted that, in the first embodiment, each cable 14 is constructed by two wires 141. However, the number of the wires 141 in each cable 14 can be adjusted based on demand. The cable 14 may be constructed by only one thicker wire 141, or constructed by three or more thinner wires 141 to make the entire cable 14 more flexible, and is not limited to the first embodiment.

The first locking structure 15 is disposed on the outer casing 11 and is adjacent to a corner between the front end surface 113 and the second side surface 116. The outer casing 11 has a recessed portion 119 located at the corner adjacent to the front end surface 113 and the second side surface 116. The first locking structure 15 is formed to be constructed integrally from the outer casing 11 and is disposed in the recessed portion 119, so that the first locking structure 15, the first contact member 12 and the second contact member 13 are triangularly arranged. It should be noted that, in other implementation examples, the first locking structure 15 may be only partially disposed in the recessed portion 119. In addition, a structure of the cable-end connector 1 at the mating surface 111 has a plane portion 111a that is adjacent to a corner of the rear end surface 114 and the first side surface 115. The plane portion 111a is on a side opposite to the recessed portion 119 and is away from the recessed portion 119. The plane portion 111a is adjacent to the first mating portion 121 of the first contact member 12 and is adjacent to the second mating portion 131 of the second contact member 13, and is arranged in a triangular arrangement with the first contact member 12 and the second contact member 13. The plane portion 111a can abut against the board-end connector 2, so that the cable-end connector 1 and the board-end connector 2 are more stable relative to each other in position and not prone to shake when they are mated with each other.

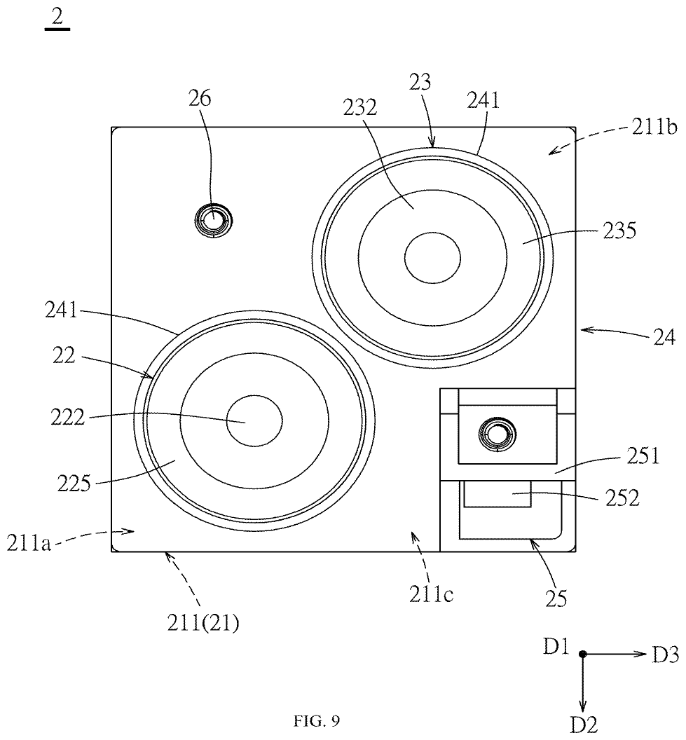

Referring to FIGS. 2, 4-6 and 9, the board-end connector 2 is used to mate with the cable-end connector 2 along the up-down direction D1, and the board-end connector 2 comprises a circuit board 21, a third contact member 22, a fourth contact member 23, a seat body 24 and a second locking structure 25.

The circuit board 21 has a rectangular region 211 that faces upwardly, a first corner 211a and a second corner 211b that are positioned diagonally opposite within the rectangular region 211, and a third corner 211c that is positioned within the rectangular region 211. It should be noted that, although the circuit board 21 is in a rectangular shape and the entire circuit board 21 is positioned within the rectangular region 211 in the first embodiment, the circuit board 21 may also be in other shapes and the rectangular region 211 may be only a part of the circuit board 21 in other embodiments.

The third contact member 22 extends along the up-down direction D1 and is disposed in the first corner 211a, and includes a third connecting portion 221 that is electrically connected to the circuit board 21, and a third mating portion 222 that is formed by extending upwardly from the third connecting portion 221 and that is used to mate with the first mating portion 121. The fourth contact member 23 extends along the up-down direction D1 and is disposed in the second corner 211b so as to be arranged diagonally to the third contact member 22, and includes a fourth connecting portion 231 that is electrically connected to the circuit board 21, and a fourth mating portion 232 that is formed by extending upwardly from the fourth connecting portion 231 and that is used to mate with the second mating portion 131. Specifically, the third mating portion 222 and the fourth mating portion 232 are cylindrical in shape, and are used to insert from the mating surface 111 respectively into the two through grooves 117b of the outer casing 11 of the cable-end connector 1, so as to be electrically connected to the elastic contact pieces 121f of the cage-shaped contact body 121d of the first mating portion 121 and the elastic contact pieces 131f of the cage-shaped contact body 131d of the second mating portion 131, respectively.

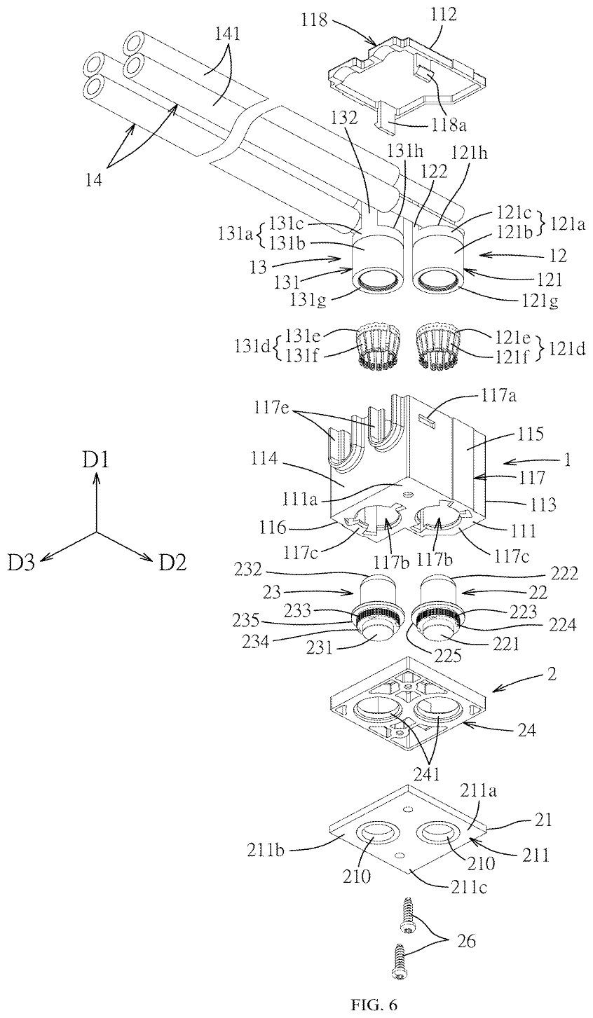

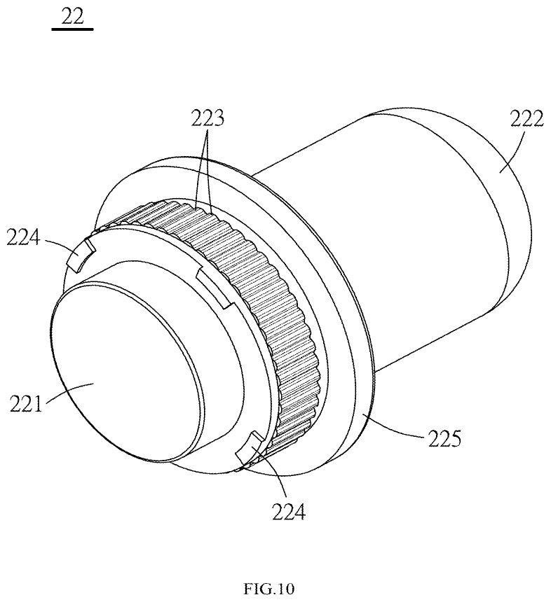

The seat body 24 is in a rectangular shape, and is disposed on the rectangular region 211 of the circuit board 21. The seat body 24 has two through holes 241 that extend through it in the up-down direction D1 and that are formed in the first corner 211a and the second corner 211b of the circuit board 21, respectively. The third mating portion 222 and the fourth mating portion 232 extend upwardly out of the two through holes 241, respectively. Specifically, the seat body 24 and the circuit board 21 are locked with each other by means of two locking screws 26. Referring to FIGS. 6 and 10, in this embodiment, the third connecting portion 221 and the fourth connecting portion 231 are soldering pins that pass through and are soldered to soldering holes 210 of the circuit board 21, respectively. The third contact member 22 and the fourth contact member 23 respectively have a stopping portion 225 and a stopping portion 235 stopped by a top surface of the seat body 24. In addition, it should be noted that, in the first embodiment, the third contact member 22 further has a plurality of interference ribs 223 that are adjacent to the third connecting portion 221 and that are used to interfere with an inner wall surface of the corresponding through hole 241, and a plurality of raising projections 224 that are adjacent to the third connecting portion 221 and that are stopped by a top surface of the circuit board 21 to raise a space for solder filling; the fourth contact member 23 further has a plurality of interference ribs 233 that are adjacent to the fourth connecting portion 231 and that are used to interfere with an inner wall surface of the corresponding through hole 241, and a plurality of raising projections 234 that are adjacent to the fourth connecting portion 231 and that are stopped by the top surface of the circuit board 21 to raise a space for solder filling. It should be noted that the function of the raising projections 224 and the raising projections 234 is to raise a space for solder filling so as to enhance the soldering strength. In other embodiments, the raising projections 224 and the raising projections 234 may be omitted.

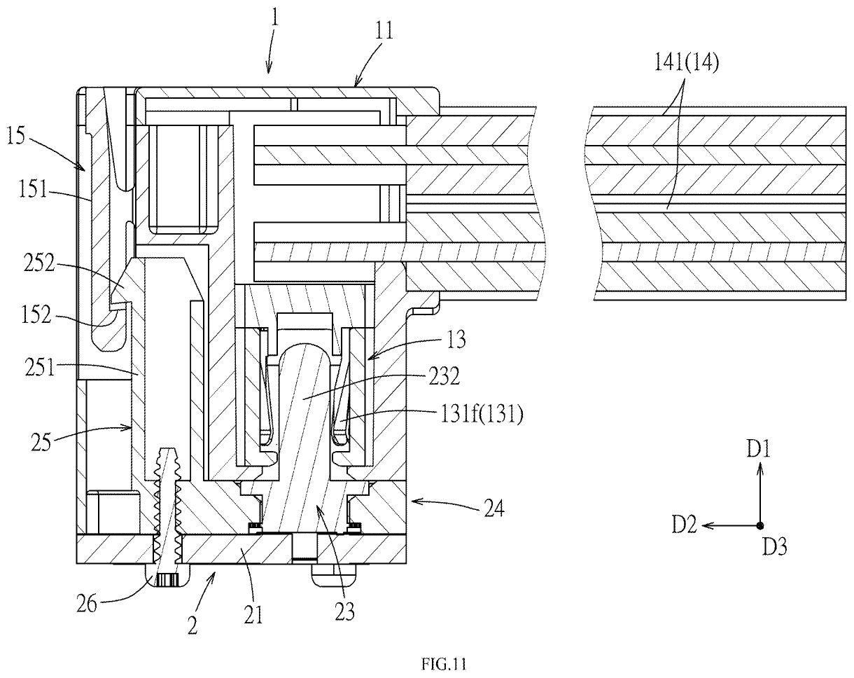

Referring to FIGS. 2, 4-6 and 11, the second locking structure 25 is disposed in the third corner 211c and extends upwardly, and is formed to be constructed integrally from the seat body 24 in the first embodiment. The second locking structure 25 is used to interlock with the first locking structure 15. The first locking structure 15 has a cantilevered arm 151 extending downwardly, and a first latching unit 152 disposed at a bottom of the cantilevered arm 151. The second latching unit 25 has a base portion 251 extending upwardly from the seat body 24, and a second latching unit 252 disposed on a top of the base portion 251 and used to latch with the first latching unit 152. For example, the first latching unit 152 may be a recess and the second latching unit 252 may be a protrusion for mating the recess, or vice versa, and they are not limited to the first embodiment.

As for the cable-end connector 1 and the board-end connector 2 as a whole, by virtue of the first contact member 12 and the second contact member 13 that are arranged diagonally and the third contact member 22 and the fourth contact member 23 that are arranged diagonally, the cable-end connector 1 and the board-end connector 2 can be reduced in width along a lateral direction (i.e., the front-rear direction D2 and the left-right direction D3), and design spaces respectively for the first locking structure 15 and the second locking structure 25 can be reserved, so that the space of the cable-end connector 1 and the space of the board-end connector 2 can be used effectively. Also, the dimensions of the first locking structure 15 and the second locking structure 25 can be designed to be larger to enhance structural strengths thereof.

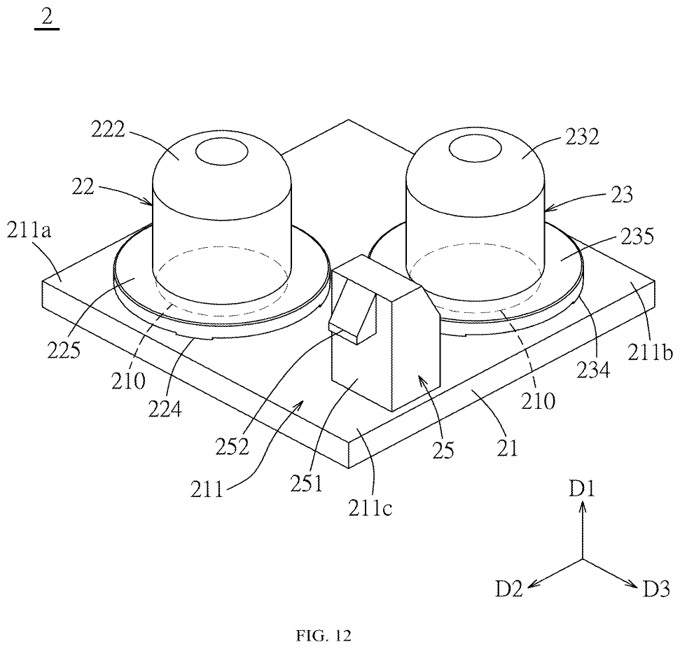

Referring to FIG. 12, a second embodiment of the assembly of the cable-end connector 1 and the board-end connector 2 of the present disclosure is different from the first embodiment in that the base portion 251 of the second locking structure 25 is directly disposed in the third corner 211c of the circuit board 21. The base portion 251 of the second locking structure 25 is disposed on the circuit board 21 by means of, for example but not limited to, assembling. In the second embodiment, the seat body 24 and the interfering ribs 223 of the third contact member 22 and the interfering ribs 233 of the fourth contact member 23 that cooperate with the seat body 24 are omitted, and the raising projections 224 are formed at a bottom of the stopping portion 225 and the raising projections 234 are formed at a bottom of the stopping portion 235. In addition, it should be noted that in a variation of the second embodiment, the raising projections 224 and the raising projections 234 can be omitted, in which case the stopping portion 225 and the stopping portion 235 are stopped by the top surface of the circuit board 21.

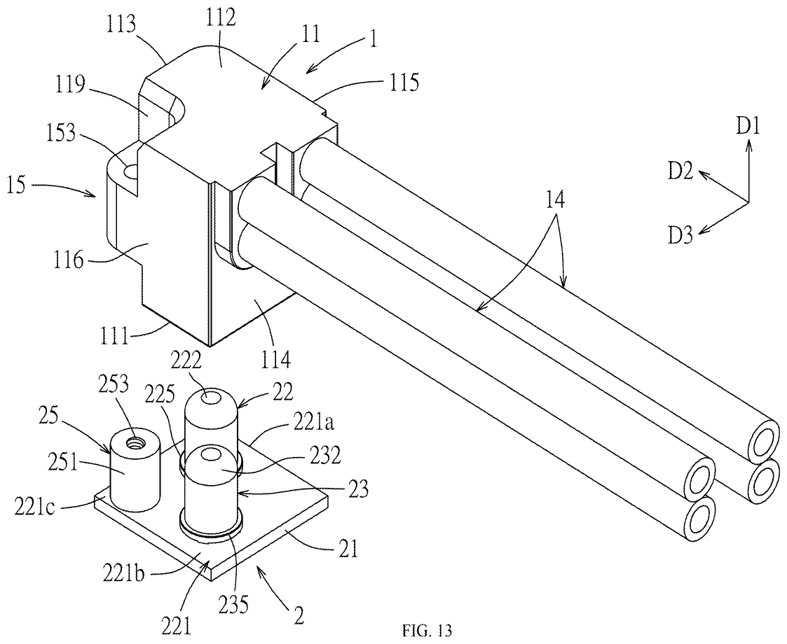

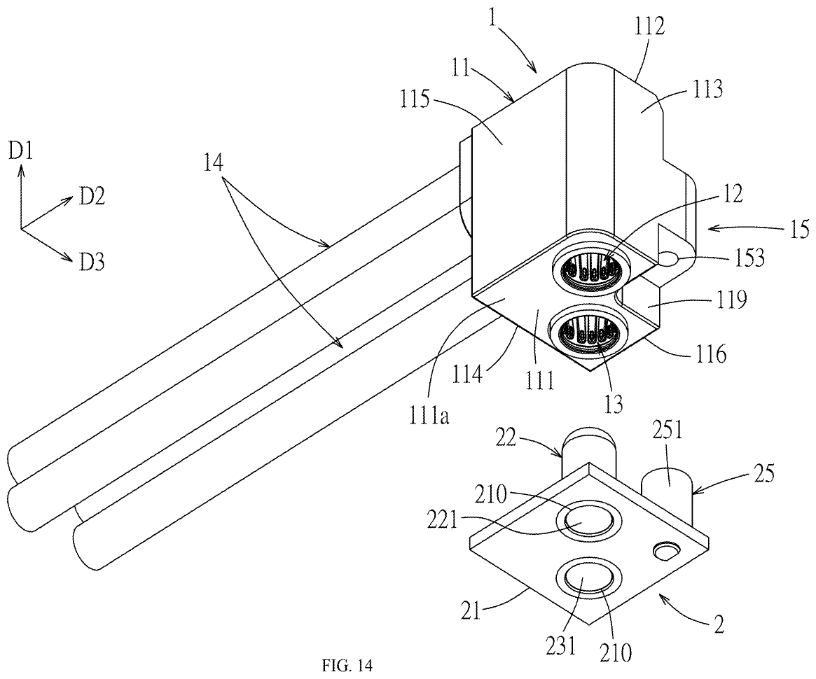

Referring to FIGS. 13 and 14, a third embodiment of the assembly of the cable-end connector 1 and the board-end connector 2 of the present disclosure is different from the second embodiment in that the outer casing 11 is integrally formed by over molding. The second locking structure 25 includes the base portion 251 that is inserted into the circuit board 21 and that extends upwardly, and a threaded hole 253 that is disposed at a top of the base portion 251. The first locking structure 15 has an opening 153 that extends through it in the up-down direction. The opening 153 and the threaded hole 253 are fastened via a screw 154 (not shown), so as to make the first locking structure 15 and the second locking structure 25 interlock.

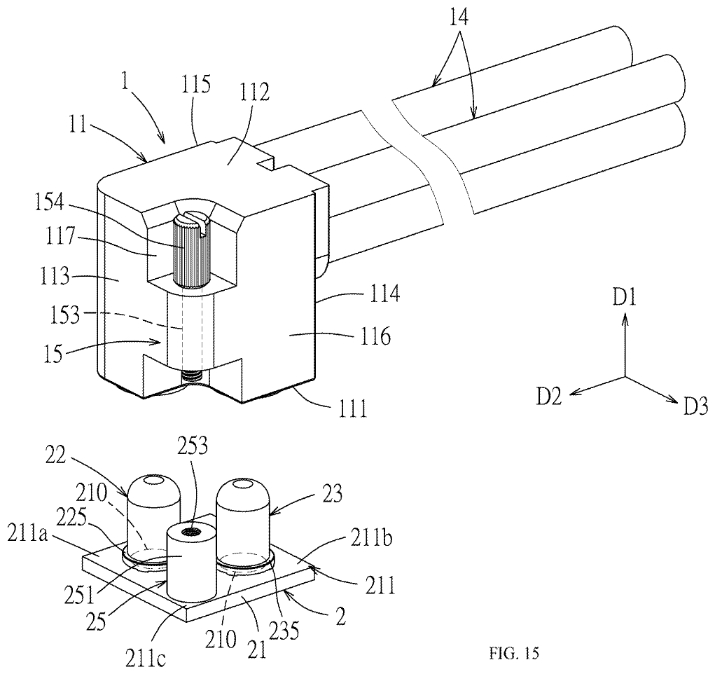

Referring to FIG. 15, a fourth embodiment of the assembly of the cable-end connector 1 and the board-end connector 2 of the present disclosure is different from the third embodiment in that the first locking structure 15 further has a screw 154 that rotatably extends through the opening 153 and that is used to engage with the threaded hole 253, thereby avoiding loss of the screw 154 and increasing convenience of locking.

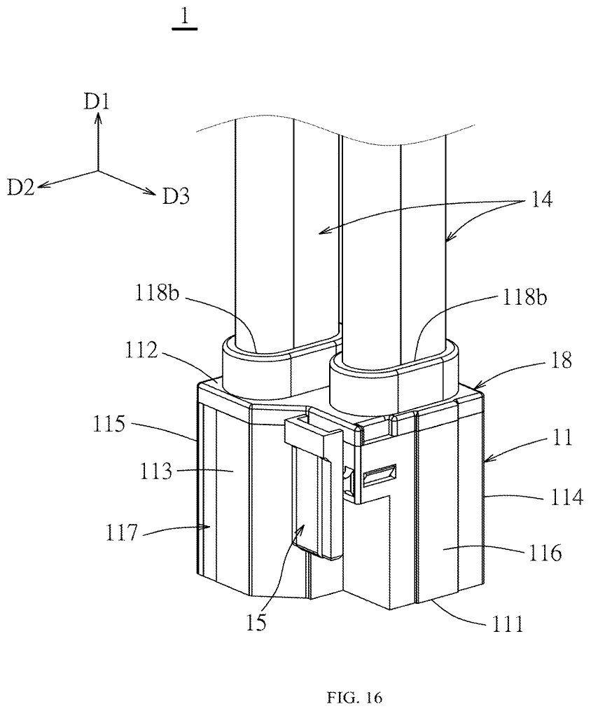

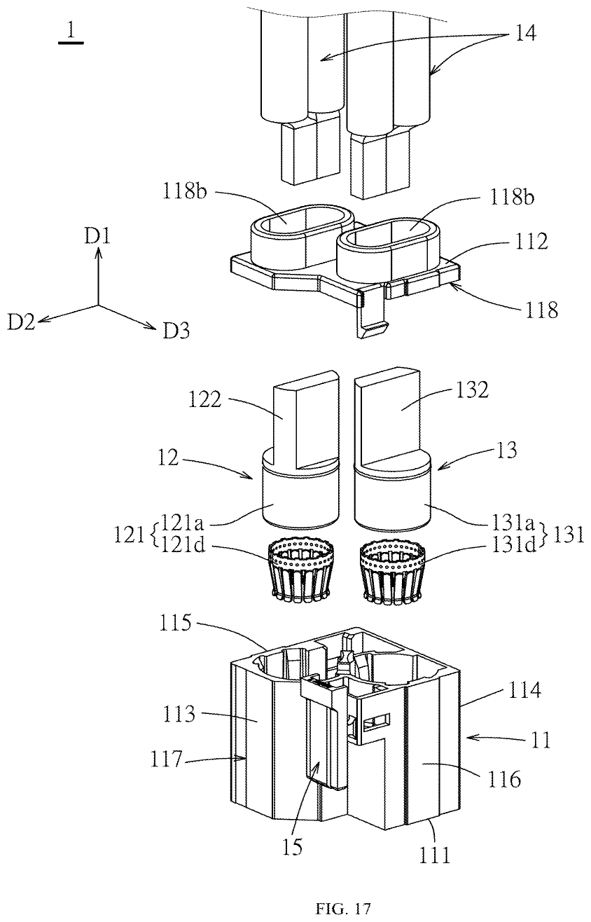

Referring to FIGS. 16 and 17, a fifth embodiment of the assembly of the cable-end connector 1 and the board-end connector 2 of the present disclosure is different from the first embodiment in that the two cables 14 extend respectively into the two through grooves 117b of the outer casing 11 respectively through two cable passing holes 118b of the cover 118 of the outer casing 11 in the upper end surface 112, and are electrically connected to the first connecting portion 122 and the second connecting portion 132, respectively.

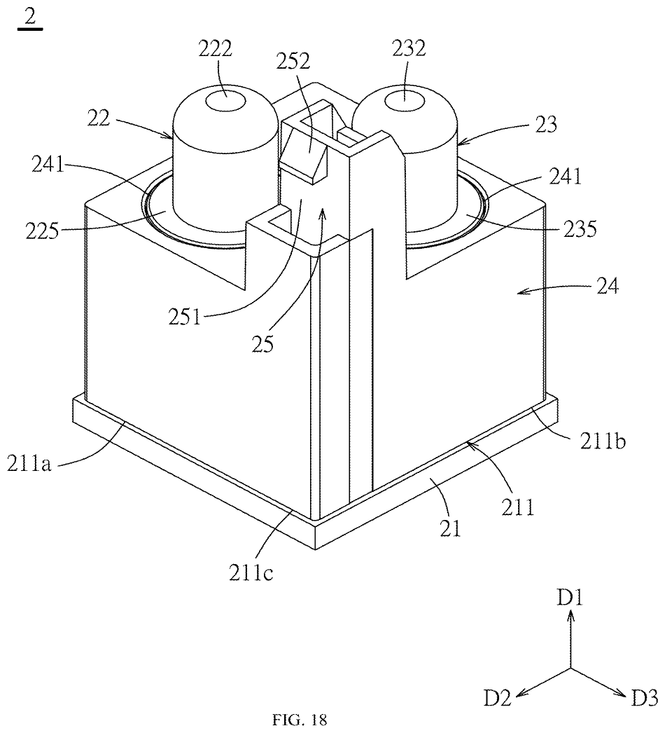

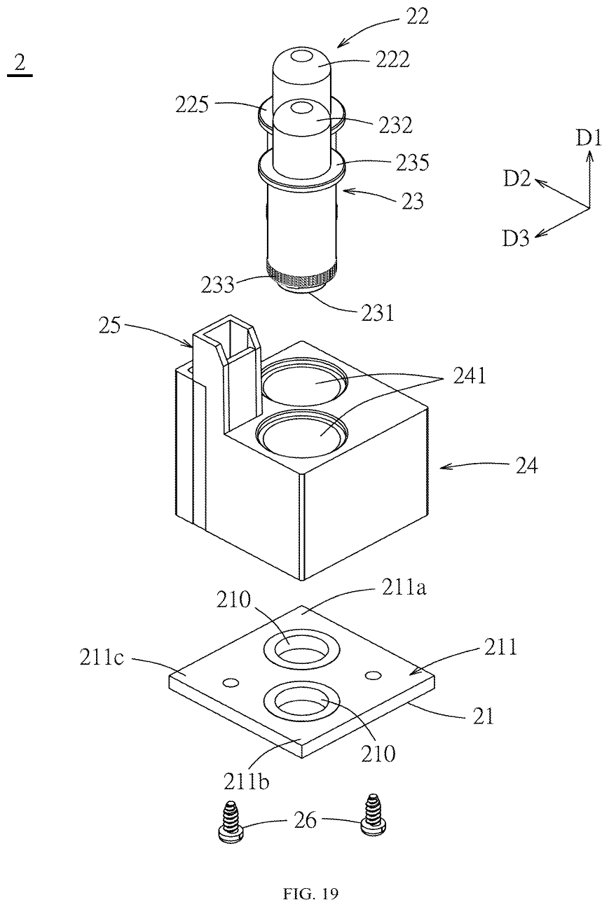

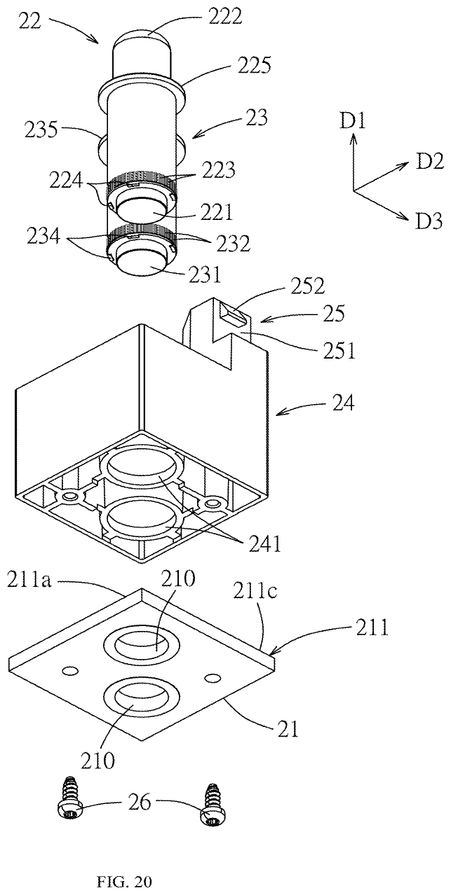

Referring to FIGS. 18-20, a sixth embodiment of the assembly of the cable-end connector 1 and the board-end connector 2 of the present disclosure is different from the first embodiment in that the seat body 24 and the through holes 241 thereof, the third contact member 22 and the fourth contact member 23 are higher in height along the up-down direction D1.

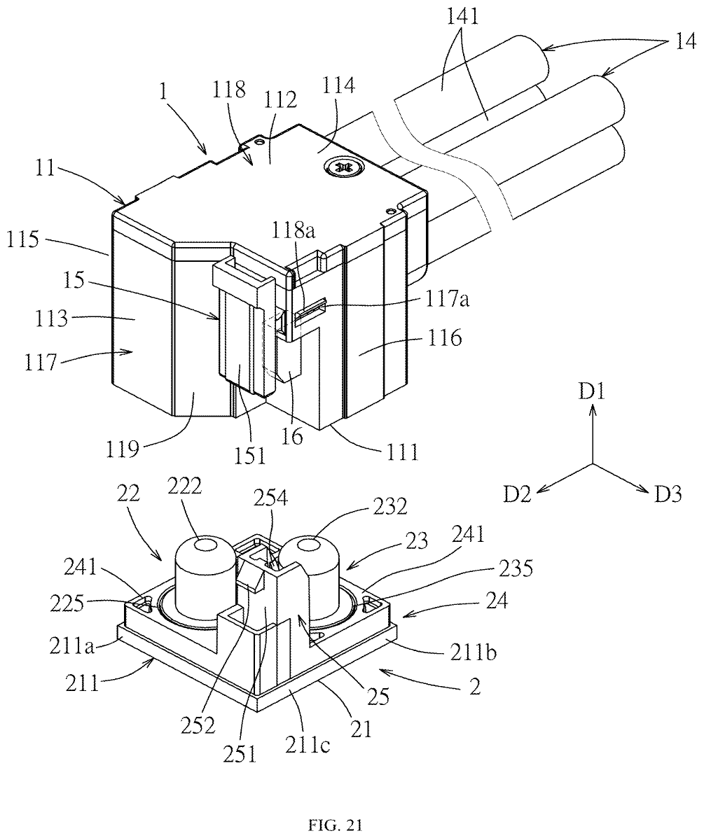

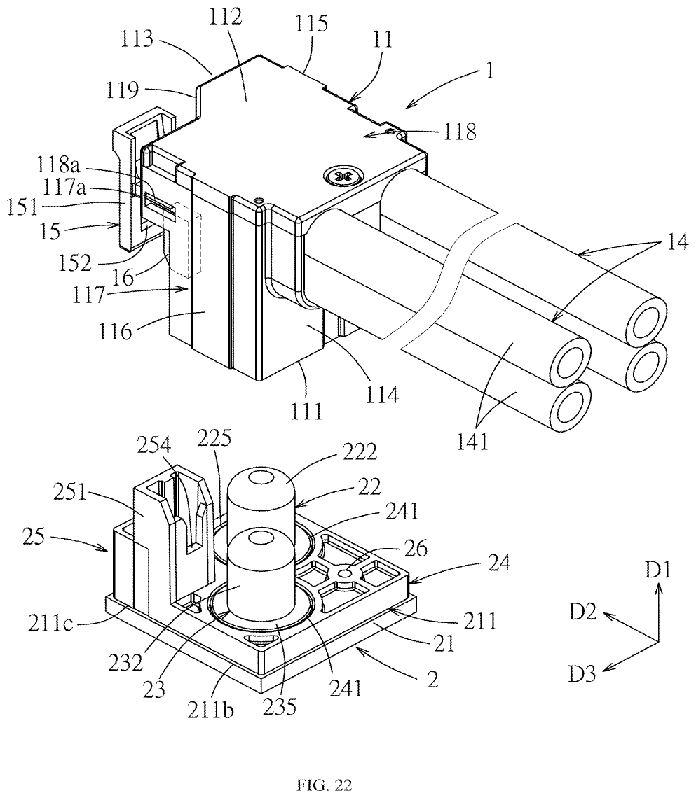

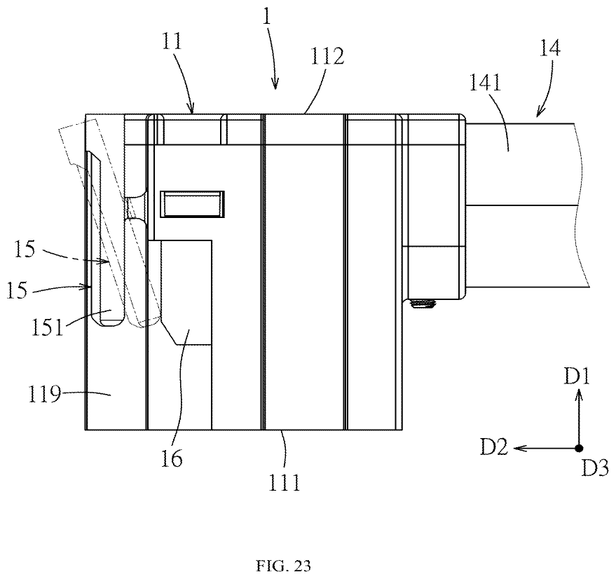

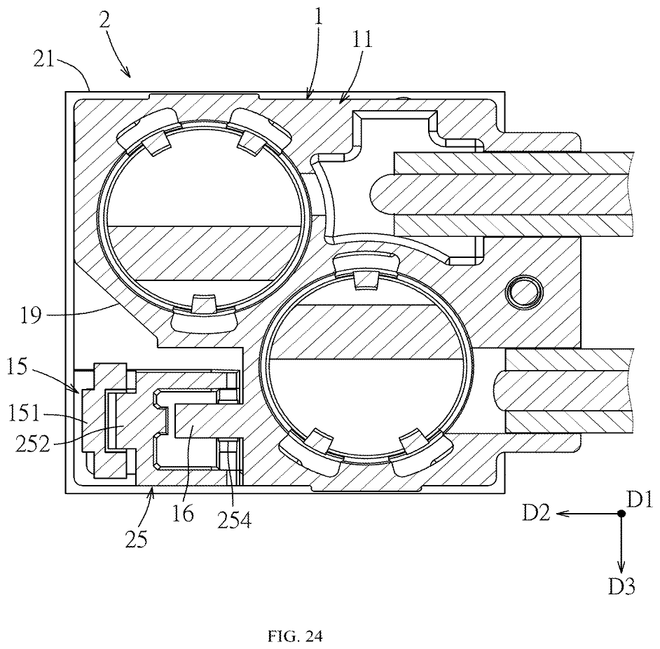

Referring to FIGS. 21-24, a seventh embodiment of the assembly of the cable-end connector 1 and the board-end connector 2 of the present disclosure is different from the first embodiment in that the cable-end connector 1 further has an abutting rib 16 disposed within the recessed portion 119 of the outer casing 11 and behind the cantilevered arm 151 of the first locking structure 15. The abutting rib 16 is capable of allowing a lower segment of the cantilevered arm 151 of the first locking structure 15 to abut against it when the lower segment of the cantilevered arm 151 of the first locking structure 15 is displaced rearwardly (see FIG. 23), so as to prevent the first locking structure 15 from being excessively deformed and damaged. The second locking structure 25 of the board-end connector 2 further includes an avoiding groove 254 formed in the base portion 251 and corresponding to the abutting rib 16. The avoiding groove 254 is used to avoid the abutting rib 16 when the first locking structure 15 interlocks with the second locking structure 25.

In summary, in the present disclosure, by virtue of the first contact member 12 and the second contact member 13 that are diagonally arranged and that are arranged in a triangular arrangement with the first locking structure 15, and the third contact member 22 and the fourth contact member 23 that are diagonally arranged, the cable-end connector 1 and the board-end connector 2 can be reduced in width along a lateral direction, and design spaces respectively for the first locking structure 15 and the second locking structure 25 can be reserved, so that the space of the cable-end connector 1 and the space of the board-end connector 2 can be used effectively. Also, the dimensions of the first locking structure 15 and the second locking structure 25 can be designed to be larger to enhance structural strengths thereof.

However, the above are merely the embodiments of the present disclosure, and certainly the scope of the present disclosure cannot be limited thereby. Any simple equivalent variation and modification made according to the claims and the contents of the specification of the present disclosure should fall within the scope covered by a patent to the present disclosure.

### DESCRIPTION OF REFERENCE NUMERALS

1: Cable-End Connector
11: Outer Casing
111: Mating Surface
111a: Plane Portion
112: Upper End Surface
113: Front End Surface
114: Rear End Surface
115: First Side Surface
116: Second Side Surface
117: Housing
117a: Latching Hole
117b: Through Groove
117c: Stopping Edge
117d: Elastic Stopping Arm
117e: Cable Passing Hole
118: Cover
118a: Latching Elastic Arm
118b: Cable Passing Hole
119: Recessed Portion
12: First Contact Member
121: First Mating Portion
121a: Barrel Body
121b: Tubular Member
121c: Lid-Shaped Member
121d: Cage-Shaped Contact Body
121e: Annular Head Portion
121f: Elastic Contact Piece
121g: Bottom Edge
121h: Upper Stopping Surface
122: First Connecting Portion
13: Second Contact Member
131: Second Mating Portion
131a: Barrel Body
131b: Tubular Member
131c: Lid-Shaped Member
131d: Cage-Shaped Contact Body
131e: Annular Head Portion
131f: Elastic Contact Piece
131g: Bottom Edge
131h: Upper Stopping Surface
132: Second Connecting Portion
14: Cable
141: Wire
15: First Locking Structure
151: Cantilevered Arm
152: First Latching Unit
153: Opening
154: Screw
16: Abutting Rib
2: Board-End Connector
21: Circuit Board
210: Soldering Hole
211: Rectangular Region
211a: First Corner
211b: Second Corner
211c: Third Corner
22: Third Contact Member
221: Third Connecting Portion
222: Third Mating Portion
223: Interfering Rib
224: Raising Projection
225: Stopping Portion
23: Fourth Contact Member
231: Fourth Connecting Portion
232: Fourth Mating Portion
233: Interfering Rib
234: Raising Projection
235: Stopping Portion
24: Seat Body
241: Through Hole
25: Second Locking Structure
251: Base Portion
252: Second Latching Unit
253: Threaded Hole
254: Avoiding Groove
26: Locking Screw
D1: Up-Down Direction
D2: Front-Rear Direction
D3: Left-Right Direction

We claim:

1. A cable-end connector, comprising:
an outer casing having a mating surface and a recessed portion;
a first contact member disposed in the outer casing and extending toward the mating surface;
a second contact member disposed in the outer casing and extending toward the mating surface;
a first cable extending into the outer casing and being electrically connected to the first contact member;
a second cable extending into the outer casing and being electrically connected to the second contact member; and
a first locking structure disposed on the outer casing, at least part of the first locking structure being positioned in the recessed portion,
wherein the recessed portion, the first contact member and the second contact member are triangularly arranged.

2. The cable-end connector as claimed in claim 1, wherein the mating surface is located at a bottom of the outer casing, and the outer casing further has a front end surface and a rear end surface that are opposite to each other, and a first side surface and a second side surface that are opposite to each other, the front end surface, the rear end surface, the first side surface and the second side surface each being formed by extending from a respective side edge of the mating surface, the recessed portion being adjacent to the front end surface or to the rear end surface.

3. The cable-end connector as claimed in claim 2, wherein
the first contact member includes a first mating portion that is disposed in the outer casing and extends toward the mating surface, and a first connecting portion connected to the first mating portion;
the second contact member includes a second mating portion that is disposed in the outer casing and extends toward the mating surface, and a second connecting portion connected to the second mating portion; and
the first cable is electrically connected to the first connecting portion, and the second cable is electrically connected to the second connecting portion.

4. The cable-end connector as claimed in claim 2, wherein the recessed portion is adjacent to a corner of the front end surface and the second side surface, the first contact member is adjacent to a corner of the front end surface and the first side surface, and the second contact member is adjacent to a corner of the rear end surface and the second side surface.

5. The cable-end connector as claimed in claim 2, wherein projections of the first contact member and the second contact member on the front end surface are partially overlapped with each other.

6. The cable-end connector as claimed in claim 2, wherein projections of the first contact member and the second contact member on the first side surface are partially overlapped with each other.

7. The cable-end connector as claimed in claim 1, wherein the first locking structure, the first contact member and the second contact member are triangularly arranged.

8. The cable-end connector as claimed in claim 7, wherein the outer casing includes a housing and a cover that are assembled with each other, the housing having two through grooves respectively accommodating the first contact member and the second contact member, each through groove is provided with a stopping edge at a bottom of the housing and adjacent to the mating surface and an elastic stopping arm extending from a top of the housing and into the through groove, the stopping edges of the through grooves are configured to respectively to stop a bottom edge of the first contact member and a bottom edge of the second contact member, and the elastic stopping arms of the through grooves are configured to respectively stop an upper stopping surface of the first contact member and an upper stopping surface of the second contact member.

9. The cable-end connector as claimed in claim 1, wherein the first locking structure has a cantilevered arm extending downwardly, and a first latching unit disposed on the cantilevered arm.

10. The cable-end connector as claimed in claim 1, wherein the first locking structure has an opening extending therethrough in an up-down direction.

11. The cable-end connector as claimed in claim 1, wherein the first locking structure has an opening extending therethrough in an up-down direction, and a locking screw rotatably extending through the opening.

12. A board-end connector, comprising:
a blocking seat;
a third contact member including a third connecting portion disposed on the blocking seat, and a third mating portion formed by extending upward from the third connecting portion;
a fourth contact member including a fourth connecting portion disposed on the blocking seat, and a fourth mating portion formed by extending upward from the fourth connecting portion; and
a second locking structure disposed on the blocking seat,
wherein the third contact member, the fourth contact member and the second locking structure are triangularly arranged.

13. The board-end connector as claimed in claim 12, wherein the blocking seat is a circuit board, the third connecting portion is electrically connected to the circuit board, and the fourth connecting portion is electrically connected to the circuit board.

14. The board-end connector as claimed in claim 13, wherein the third contact member further has a stopping portion that is stopped by a top surface of the circuit board, and the fourth contact member further has a stopping portion that is stopped by the top surface of the circuit board.

15. The board-end connector as claimed in claim 12, wherein the second locking structure includes a base portion extending upwardly, and a second latching unit disposed on the base portion.

16. The board-end connector as claimed in claim 12, wherein the second locking structure includes a base portion extending upwardly, and a threaded hole disposed on the base portion.

17. The board-end connector as claimed in claim 12, wherein the blocking seat is a seat body in a rectangular shape, the seat body has two through holes each extending therethrough in an up-down direction, and the third mating portion and the fourth mating portion extend upwardly out of the two through holes, respectively.

18. The board-end connector as claimed in claim 17, wherein the third contact member further has a stopping portion that is stopped by a top surface of the seat body, and the fourth contact member further has a stopping portion that is stopped by the top surface of the seat body.

19. The board-end connector as claimed in claim 12, wherein the third mating portion and the fourth mating portion are cylindrical in shape.

20. An assembly comprising:
a cable-end connector comprising:
an outer casing having a mating surface and a recessed portion;
a first contact member disposed in the outer casing and extending toward the mating surface;
a second contact member disposed in the outer casing and extending toward the mating surface;
at least one first cable extending into the outer casing and being electrically connected to the first contact member;
at least one second cable extending into the outer casing and being electrically connected to the second contact member;
a first locking structure disposed on the outer casing, at least part of the first locking structure being positioned in the recessed portion,
wherein the recessed portion, the first contact member and the second contact member are triangularly arranged; and
a board-end connector configured to mate with the cable-end connector, and the board-end connector comprising:
a blocking seat;
a third contact member including a third connecting portion disposed on the blocking seat, and a third mating portion extending upward from the third connecting portion and configured to mate with the first mating portion;
a fourth contact member including a fourth connecting portion disposed on the blocking seat, and a fourth mating portion extending upward from the fourth connecting portion and configured to mate with the second mating portion; and
a second locking structure disposed on the blocking seat, the second locking structure being configured to interlock with the first locking structure,
wherein the third contact member, the fourth component and the second locking structure are triangularly arranged.
